(19) United States
(12) Patent Application Publication
(10) Pub. No.: US 2024/0144845 A1
(43) Pub. Date: May 2, 2024

(54) TACTILE TISSUE SIMULATING STRUCTURES

(71) Applicant: TACTILE ORTHOPAEDICS INC., Calgary (CA)

(72) Inventors: Gwendolyn Mary-jean Morgan, Calgary (CA); Christopher Ryan Martin, Calgary (CA); Carolyn Ruth Anglin, Calgary (CA); Daniel Zahynacz, Calgary (CA); Anthony Thomas Demong, Regina (CA); Chun Kim, Calgary (CA); Ian K. Lo, Calgary (CA); Emily Grace Abelseth, Calgary (CA)

(21) Appl. No.: 18/279,572

(22) PCT Filed: Feb. 28, 2022
(86) PCT No.: PCT/CA2022/050281

§ 371 Date: Aug. 30, 2023

Related U.S. Application Data
(60) Provisional application No. 63/154,904, filed on Mar. 1, 2021.

(51) Int. Cl. G09B 23/30

(52) U.S. Cl. CPC G09B 23/30

(57) ABSTRACT

Materials and methods for producing tactile anatomical structures are described. These are intended primarily for use for high-value, in-depth surgical training for novice or expert surgeons. They may also be used for medical education, sales demonstrations, or for research and development. Examples of embodiments refer to their use in knee and shoulder models. The tactile tissue-simulating structures include, amongst others: skin, fat, muscles, ligaments, tendons, cartilage, bursa, fat pad, and periosteum. A method for creating a musculotendinous junction is also described.

### CROSS REFERENCE TO RELATED APPLICATION

This application claims priority to U.S. Provisional Patent Application 63/154,904, filed Mar. 1, 2021, the entire contents of which is hereby incorporated by reference.

### FIELD

The present disclosure relates generally to tissue simulating structures, for example, for artificial skin and soft tissues for use in human and animal surgical training, demonstrations and medical education.

### BACKGROUND

There is increasing recognition that training outside the operating room (OR) benefits learners, patients and the healthcare system.

Learners, whether novice or expert surgeons learning new techniques, benefit by practicing in a safe environment, performing the entire procedure, performing or discussing alternate approaches, having multiple repetitions, and comparing their performance to peers or experts.

Patients benefit by not being the surgeon's first experience with a new procedure, and by likely having a higher probability of a good outcome.

The healthcare system benefits by potentially having shorter surgeries as well as fewer complications, which can result in more follow-up visits and possible revision surgery.

Some surgeries, such as orthopaedic surgeries, are hands-on procedures in which the tactile feedback plays a key role. Replicating the tissue feel is helpful to allow a model to mimic the tactile surgical environment. Surgeons typically do not have an objective method of judging how much force they should use when performing tasks, and instead rely on feel.

Training with a physical simulator, for example for surgical training or medical education, offers the opportunity to learn, practice, understand and gain confidence in a procedure before working on a patient. The more realistic the tactile feel, the more closely the user can replicate the experience with the patient, the more immersed the user is in the experience, and the better prepared the user can be.

### SUMMARY

In one aspect, there is provided a tissue-simulating structure comprising:
a polymer; and
a lubricant.

In one example, the polymer is polyurethane rubber, silicone, silicone rubber, or combinations thereof.

In one example, the polyurethane rubber has a Shore hardness of between 5A and 90A.

In one example, wherein the polyurethane rubber has a Shore hardness of 5A, 10A, 20A, 30A, 40A, 50A, 60A, 70A, 80A or 90A.

In one example, the lubricant is mineral oil, glycerin, jojoba oil, olive oil, polyurethane softening agent or combinations thereof.

In one example, the lubricant is about 5% wt/wt to about 50% wt/wt, relative to the total amount of polymer.

In one example, the lubricant is about 5% wt/wt, about 10% wt/wt, about 15% wt/wt, about 20% wt/wt, about 25%, wt/wt, about 30% wt/wt, about 35% wt/wt, about 40% wt/wt, about 45% wt/wt or about 50% wt/wt.

In one aspect there is provided a tissue-simulating structure, comprising:
a polymer;
a lubricant; and
a porous material.

In one example, the polymer is polyurethane rubber, silicone, silicone rubber, or combinations thereof.

In one example, the polyurethane rubber has a Shore hardness between 5A and 90A.

In one example, the lubricant is a mineral oil, glycerin, jojoba oil, olive oil, polyurethane softening agent or combinations thereof.

In one example, the lubricant is mineral oil.

In one example, the lubricant is about 5% wt/wt to about 50% wt/wt.

In one example, the lubricant is about 5% wt/wt, about 10% wt/wt, about 20% wt/wt, about 30% wt/wt, about 40% wt/wt or about 50% wt/wt.

In one example, the porous material comprises one or more layers of open-cell polyurethane foam or another synthetic foam, or natural fabric, or felt, or combinations thereof.

In one example, the porous material comprises one or more layers of open-cell polyurethane foam.

In one example, the porous material comprises one or more layers of 1/16″ to ½″ open-cell polyurethane foam.

In one example, the porous material comprises a total of ⅛″ thickness of open-cell polyurethane foam.

In one example, the porous material has a ⅛″ thickness in areas where the fat and muscle layers are thinner, ¼″ in areas of medium thickness and ½″ where the fat and muscle layers are thicker.

In one example, the surface of the polymer includes skin-like texture, for example, Langer's lines (a surface pattern that follows the collagen orientation within the dermis).

In one example, further comprising a flexible mesh fabric.

In one example, the mesh comprises polyamide.

In one example, the mesh comprises nylons or a synthetic or natural elasticized fabric.

In one aspect, there is provided a tissue-simulating structure comprising:
a polymer; and
a softener.

In one example, the polymer is polyurethane rubber, silicone, silicone rubber, or combinations thereof.

In one example, the polyurethane rubber has a Shore hardness of between 5A and 30A.

In one example, the polyurethane rubber has a Shore hardness of 5A, 6A, 7A, 8A, 9A, 10A, 11A, 12A, 13A, 14A, 15A, 16A, 17A, 18A, 19A, 20A, 21A, 22A, 23A, 24A, 25A, 26A, 27A, 28A, 29A, or 30A.

In one example, the softener is a polyurethane softening agent, such as So-Flex.

In one example, the softener is about 5% wt/wt to about 30% wt/wt, relative to the total amount of polymer.

In one example, the softener is about 5% wt/wt, about 6% wt/wt, about 7% wt/wt, about 8% wt/wt, about 9% wt/wt, about 10% wt/wt, about 11% wt/wt, about 12% wt/wt, about 13% wt/wt, about 14% wt/wt, about 15% wt/wt, about 16% wt/wt, about 17% wt/wt, about 18% wt/wt, about 19% wt/wt, about 20% wt/wt, about 21% wt/wt, about 22% wt/wt, about 23% wt/wt, about 24% wt/wt, about 25% wt/wt, about 26% wt/wt, about 27% wt/wt, about 28% wt/wt, about 29% wt/wt, or about 30% wt/wt, relative to the total amount of polymer.

In one example, further comprising a lubricant, wherein the lubricant is mineral oil, glycerin, jojoba oil, olive oil, polyurethane softening agent or combinations thereof.

In one example, the lubricant is about 5% wt/wt to about 20% wt/wt, relative to the total amount of polymer.

In one example, the lubricant is about 5% wt/wt, about 6% wt/wt, about 7% wt/wt, about 8% wt/wt, about 9% wt/wt, about 10% wt/wt, about 11% wt/wt, about 12% wt/wt, about 13% wt/wt, about 14% wt/wt, about 15% wt/wt, about 16% wt/wt, about 17% wt/wt, about 18% wt/wt, about 19% wt/wt, or about 20% wt/wt, relative to the total amount of polymer.

In one example, further comprising an extension-limiting component.

In one example, the extension-limiting component is braided thread, braided multifilament thread, monofilament thread, suture material, wire, fishing line, yarn, rope, fabric, a minimally-extensible plastic or combinations thereof.

In one example, the extension-limiting component is braided multifilament thread.

In one example, the extension-limiting component is braided multifilament thread with a breaking strength of at least 25 lbf.

In one example, the extension-limiting component is attached to a point on each connecting bone, thereby limiting the movement of the bones relative to each other.

In one example, the extension-limiting component is disposed on an exterior surface of the tissue-simulating structure, passing outside the corresponding structure being limited.

In one example, the extension-limiting component passes inside the corresponding structure being limited.

In one aspect, there is provided a tissue-simulating structure, comprising:
a polymer; and
elongated fibers.

In one example, the polymer is polyurethane rubber, silicone, silicone rubber, or combinations thereof.

In one example, the polymer is polyurethane rubber having a Shore hardness between 5A and 90A.

In one example, the polymer is a silicone rubber.

In one example, the elongated fibers comprise animal fiber, preferably silk, horse hair, wool, human hair, non-human animal hair, synthetic fiber, preferably acrylic, polyester, polyvinyl chloride (PVC); and/or organic fibers, preferably cotton, hemp, or bamboo.

In one example, the elongated fibers are silk fibers.

In one example, the elongated fibers are oriented according to the structure, in a substantially parallel direction or substantially perpendicular direction or substantially cross-hatched pattern or substantially fanned layout or substantially at the periphery of the tissue-simulating structure or in random directions or combinations thereof.

In one example, the structure includes a deliberate tear or disruption to represent an anatomical defect.

In one aspect, there is provided a tissue-simulating structure comprising:
a polymer; and
an extension-limiting component.

In one example, the extension-limiting component is braided thread, braided multifilament thread, monofilament thread, suture material, wire, fishing line, yarn, rope, fabric, a minimally-extensible plastic or combinations thereof.

In one example, the extension-limiting component is inside or outside the polymer.

In one example, the polymer is polyurethane, or silicone, or silicone rubber, or combinations thereof.

In one aspect, there is provided a tissue-simulating structure comprising:
a polymer; and
a thin rubber-like membrane.

In one example, the thin rubber-like membrane is natural or synthetic rubber latex or nitrile rubber or neoprene or isoprene to create tactile resistance to surgical instruments.

In one example, the polymer is polyurethane, or silicone, or silicone rubber, or combinations thereof.

In one example, the thin rubber-like membrane has a thickness of between 0.05 mm and 0.5 mm.

In one example, further comprising one or more anchors disposed on an outer surface of said tissue-simulating structure.

In one example, the anchor comprises: a polyurethane rubber with a Shore hardness of 40A-90A, preferably 60A, preferably the anchor is a barb.

In one aspect, there is provided a tissue-simulating structure, comprising:
a biopolymer; and
a plasticizer.

In one example, the biopolymer is a gelatin, polysaccharide, preferably, seaweeds, such as algae, alginate, kappa carrageenan, or agarose, vegetable starch, guar gum, chitosan, pectin, or ground fruit pits), or polylactic acid (PLA), and further comprising water.

In one example, the plasticizer is glycerin or mineral oil.

In one aspect, there is provided a tissue-simulating structure, comprising:
a biopolymer; and
a hardener.

In one example, the biopolymer is a gelatin, polysaccharide, preferably, seaweeds, such as algae, alginate, kappa carrageenan, or agarose, vegetable starch, guar gum, chitosan, pectin, ground fruit pits, or polylactic acid (PLA), and further comprising water.

In one example, the hardener is a polymer.

In one example, the polymer is a polyurethane casting resin.

In one aspect, there is provided a muscle composite, comprising:
a simulated muscle belly, a first end and a second end;
the first end comprising a first tendon, the second end comprising a second tendon;
the simulated muscle belly comprising silicone or silicone rubber;
the first tendon comprising polyurethane rubber, having a Shore hardness between 5A and 90A;
the second tendon comprising an elasticized material; and
a musculotendinous junction connecting the muscle belly and the first tendon.

In one example, further comprising elongated fibers.

In one example, the elongated fibers comprise animal fiber, preferably silk, horse hair, wool, human hair, non-human animal hair, synthetic fiber, preferably acrylic, polyester, polyvinyl chloride (PVC); and/or organic fibers, preferably cotton, hemp, or bamboo.

In one example, the elongated fibers are silk fibers.

In one aspect, there is provided a method of producing a musculotendinous junction, comprising:
providing a muscle composite comprising a simulated muscle belly and a first end;
the first end comprising a first tendon;
the muscle belly comprising silicone or silicone rubber;
the first tendon comprising polyurethane rubber, having a Shore hardness between 5A and 90A; and
elongated fibers attached to said first end of said muscle belly and to the first tendon.

In one example, the elongated fibers comprise animal fiber, preferably silk, horse hair, wool, human hair, non-human animal hair, synthetic fiber, preferably acrylic, polyester, polyvinyl chloride (PVC); and/or organic fibers, preferably cotton, hemp, or bamboo.

In one example, the elongated fibers are silk fibers.

In one example, the elongated fibers are disposed within the muscle.

In one example, the simulated muscle belly and first tendon are coated with a silicone-adhesive composite, or a silicone, or kappa carrageenan.

In one example, the silicon-adhesive composite is Sil-poxy.

### BRIEF DESCRIPTION OF THE DRAWINGS

Embodiments of the present disclosure will now be described, by way of example only, with reference to the attached Figures.

FIG. 1A depicts a knee joint (2) with soft tissues.

FIG. 1B depicts a knee joint with a skin sleeve (4).

FIG. 2 depicts a front view of a knee joint with soft tissues, including an anterior cruciate ligament (ACL) (6), posterior cruciate ligament (PCL) (8), meniscus (10), cartilage (12) and capsule (14).

FIG. 3A depicts a skin sleeve (4) with Langer's lines (16)

FIG. 3B depicts a skin sleeve (4) with an outer skin layer (18), inner fat layer (20) and muscle-simulating insert (22).

FIG. 4A depicts a ligament made from elongated fibers (24) embedded in a polymer.

FIG. 4B depicts a posterior cruciate ligament (8) made from elongated fibers (24) embedded in a polymer.

FIG. 4C depicts a side view of a knee, showing an extension-limiting component (26), which limits the amount that the knee can rotate sideways (into the page), mimicking anatomic behavior.

FIG. 4D depicts a side view of a knee, showing the combined patellar ligament and quadriceps tendon (28), iliotibial (IT) band (30), biceps femoris (32), fat pad (34) and capsule (14).

FIG. 4E depicts elongated fibers (silk fibers) (24) being cut to a given length and divided into a given number of segments, to be spread into a mold for embedding into a polymer.

FIG. 5A depicts a muscle belly (36), tendon (38) and musculotendinous junction (40) demonstrated on a shoulder model.

FIG. 5B depicts elongated fibers (24) adhered to a tendon (38) and embedded into a muscle belly (36) to form a musculotendinous junction, to be covered by another layer of silicone rubber to complete the muscle belly.

FIG. 6 depicts a thin capsule (14) with embedded fibers (24) for the shoulder joint.

FIG. 7A depicts a meniscus (10) with horizontal cleavage tear (42) and capsular extension (44).

FIG. 7B depicts an arthroscopic camera view of a horizontal cleavage tear (42) in a meniscus (10) between the femur (46) and tibia (48) in a synthetic knee joint.

FIG. 8 depicts a synthetic hamstring tendon autograft (50), a synthetic Achilles tendon allograft (52), and a synthetic quadriceps tendon (54) with attached sutures (56).

FIG. 9 depicts a meniscus (10) with anchors (58) to allow replacement, for example for different meniscal tears.

### DETAILED DESCRIPTION

Generally, the present disclosure provides tissue-simulating structures.

Since the skin is the first entry point into the inside of the body, its tactile realism is important, not only in its own right, but also to prepare for the subsequent tactile experience. For surgical training, the most important tactile component for the skin relates to the interaction with the surgical instruments. This includes: cutting with a scalpel, suturing with a needle, opening with retractors, holding with forceps, cutting with scissors, operating an arthroscope or laparoscope inserted through a skin portal, utilizing other surgical tools through a skin portal, passing a reamer through the portal, releasing ligaments through a pie-crusting technique, and many other procedures.

From a functional point of view, when cutting with a scalpel it is important that the artificial skin does not tear beyond the cut. Similarly, when pulling sutures tight, the sutures should not tear through the skin. When passing a reamer through the artificial skin, it is important that the reamer does not catch on the artificial skin, aided by a self-lubricating feature.

In some examples, the tissue simulating structures described herein may be sutured and retain the suture stitch(es) under loads ranging from 10 to 100 N. It will be appreciated that the structural suture failure load depends on the cross-sectional area of the material at the suture location.

The texture of the skin also plays a role in the visual and tactile experience. Recreating the texture of the skin, including the Langer's lines, is important for some surgical techniques. Since Langer's lines are parallel to the collagen fibers in the dermis of the skin, it is less disruptive to make incisions parallel to the Langer's lines, to promote healing. This can be learned before working on a patient if included in a physical simulator.

Palpation of bony landmarks through the skin is important for many surgical and non-surgical techniques. For example, for the knee joint, it is often necessary to feel the kneecap (patella) and front of the shin bone (tibial crest) through the skin; therefore the skin layer should be relatively thin over these areas. Conversely, there are other areas of bone that should be more difficult to palpate, implying a thicker structure.

A multilayered skin, including an outside skin layer and an inside fat layer replicates the tactile feel and realism further.

Ligaments (as well as tendons and other structures such as the meniscus and labrum) consist generally of collagenous fibers embedded in a matrix material, initially providing limited resistance to tension, then becoming increasingly stiff, resulting in a non-linear force-elongation curve. Embedding fibers or other stiffer materials into an artificial ligament helps to mimic both the tactile feel of the ligament itself as well as the combined tactile feel of the entire joint, and helps to resist tearing, cutting or rupture. Adding a stiffer material, which is referred to as defined herein as an “extension-limiting component”, that becomes taut with increased displacement of the ligament, thereby provides an extension limit or hard stop, thus mimicking the anatomic behavior of ligaments. Having the correct tensions in the ligaments is important for learning to properly use the implants and instruments before using them on a patient.

Ligament balancing and ligament releases, including pie-crusting techniques, are important elements to a number of orthopaedic surgeries, including knee joint replacement and sports medicine surgeries. Embedding fibers or other secondary materials into the artificial ligaments allows this technique to be learned and practiced, substantially increasing the value and opportunities of the training.

Ligaments in the knee joint are usually reconstructed with grafts from the quadriceps, hamstrings, Achilles or patellar tendons. Graft preparation, including suturing techniques, is an integral part of a ligament reconstruction procedure. Currently very simple replacements are used in physical simulators (e.g. shoelaces). Creating a physically simulated graft that more closely replicates the shape, tension and suturing of the graft material provides a stronger learning experience.

The meniscus in the knee or the labrum in the shoulder is the source of many injuries needing repair, leading to sports medicine surgeries. A meniscus or “meniscus-like tissue” refers to a C-shaped piece of cartilage-like material that acts as a shock absorber between the tibia (shinbone) and femur (thighbone). A labrum or “labrum-like tissue” refers to a cup-shaped rim of cartilage-like material that lines and reinforces a ball-and-socket joint, such as the hip or shoulder. Replicating the tactile feel of the meniscus or labrum during suturing allows better practice with the instruments before using them on a patient. It is important that the meniscus or labrum material prevents pull-out of the sutures, under loads from 10 N to 100 N. Replicating the full mechanics of the knee or shoulder, including the difficulty of accessing the meniscus or labrum, achieved through the tactile feel of the other structures of the knee or shoulder, is an important component of learning new techniques or new instruments.

Being able to easily replace the meniscus or labrum within the physical simulator allows repeated practice with the same or different types of meniscal or labral tears.

When performing meniscal repair, there is a tactile ‘pop’ sensation when passing the sutures through the joint capsule. Replicating this capsular feel, potentially with a thin 0.05 mm-0.5 mm membrane, allows learners to understand how to properly suture the meniscus.

Muscles play an integral role within joints, especially in the shoulder and hip. For surgical training, it is important to replicate the tactile feel of a scalpel or rotary instruments passing through the muscle, as well as the general passive function of shortening and lengthening of the muscle with movement of the joint. The complexity of simulating a muscle comes from needing to join the relatively rigid tendon to the larger, softer muscle belly, and to include an elasticized response. A further complexity is to combine two materials that do not adhere to one another, such as polyurethane and silicone. Adding a self-lubricating feature improves the interaction with surgical instruments.

Cartilage is a complex, thin, multilayered structure protecting the surface of joints, consisting of a superficial zone, middle zone and deep zone. The outer layer is typically softer and the middle and deep layers harder, with different fiber orientations in each layer. The level of tactile fidelity of the cartilage depends on the surgical application. Different materials may therefore be used to replicate the cartilage surface, depending on the application. Another feature of the cartilage is that it should be sawable with minimal smoke or melting or residue, particularly for knee joint replacement or meniscal repair, while being soft enough to replicate, for example, cartilage lesion treatment. An important part of training in arthroscopic surgery is to prevent scoring of the cartilage (i.e. leaving a mark) with the camera or instruments. Therefore, a material that shows evidence of surface scoring adds to the training value.

Fibers play several important roles in tissues and in tissue-simulating structures. In addition to strengthening the structure, they provide heterogeneity, tactile feel, anatomic appearance, robustness to tearing, and the ability to sequentially release tissues by means of the pie-crusting technique. The amount, layout, orientation, and alignment of the fibers affects the tensile properties as well as suture pull-out strengths. These vary according to each tissue type. Since ligaments act longitudinally, their fibers are oriented longitudinally. Muscles with larger muscle bellies may fan out. The joint capsule has a dense cross-hatched network of fibers. Meniscal and labral fibers are oriented circumferentially since the meniscus and labrum themselves are roughly elliptical in shape.

A number of other anatomical tissues, such as fat, fat pad, bursa, fascia, periosteum, and intervertebral discs can be replicated in similar ways, with varying degrees of hardness and composite structure.

In some examples, a tissue-simulating structure may also be referred to as “artificial skin” or “artificial ligament” or “artificial tendon” or “artificial muscle” or “artificial meniscus” or “artificial labrum” or “artificial capsule” or “artificial fat pad” or “artificial fat” or “artificial membrane” or “artificial fascia” or “artificial cartilage” or “artificial bursa” or “artificial periosteum”.

An artificial skin may represent the skin alone, or include underlying tissues as well. For example, the tactile feel and look of the muscle bulk can be represented through differing thicknesses in the artificial skin. Alternatively, the skin may have multiple layers including, for example, a fat layer. Or, the skin may have an insert to represent the muscles. If surrounding a joint such as the knee or shoulder, the skin may be in the form of a sleeve rather than a solid unit, with closely defined variable thicknesses throughout the skin sleeve. Different materials can be used to represent the outer skin layer (epidermis), inner skin layer (dermis), fat and muscle.

Accordingly, in some examples, the tissue-simulating structure has skin-like properties.

Since the artificial skin may be used for demonstrations by people without gloves or lab coats, and potentially for extended periods of time, it is preferable if the artificial skin does not need to be kept moist, and can be handled freely without leaving a residue.

One of the most common medical procedures is suturing wounds. This is a challenging skill, which benefits from practice before working with a patient. The artificial skin material described can be used either in a sleeve or other format, around a joint or other anatomical features, leading to multiple functions, or as a flat pad dedicated to suture practice.

The tactile feel of other soft tissues are likewise important for surgical training and medical education.

In some examples, a tissue-simulating structure has ligament-like properties, with similar force-displacement behavior and similar anatomical attachments to human ligaments, and generally functions to connect two bones.

In some examples, a tissue-simulating structure has tendon-like properties, with similar tactile feel for suturing as well as the tactile feel and geometry to create artificial grafts for ligament reconstruction, and generally functions to connect muscles to bone.

In addition to having the appropriate geometry, tendon grafts should hold a suture well, since the sutures will be used to pull on the graft during the procedure, and should have similar elasticity to real tendons.

In some examples, a tissue-simulating structure has meniscus-like or labrum-like properties, having the tactile feel of suturing and with attachments and geometry mimicking human menisci or labrum. The meniscus or labrum may include a deliberate tear or defect, such that it can be repaired.

In some examples, a tissue-simulating structure has joint-capsule-like properties, having the tactile feel of suturing and tensions similar to those in the human joint, including the possibility of embedded ligaments.

In some examples, a tissue-simulating structure has muscle-like properties, having the tactile feel of cutting through the muscles as well as having the passive function of shortening and lengthening as the joint is moved.

In some examples, a tissue-simulating structure has cartilage-like properties, having the tactile feel of cutting with surgical instruments and with protective wear properties to cover a bone surface.

In some examples, there is provided a tissue-simulating structure.

The tissue-simulating structure may be used to simulate tissue from a mammal.

Mammals include but are not limited to domesticated animals, such as cats, dogs, etc., livestock (e.g., cattle, horses, pigs, sheep, goats, etc.), laboratory animals (e.g., mouse, rabbit, rat, guinea pig, etc.), non-human mammals, primates, non-human primates, rodents, and any other animal. In a specific example, the mammal is a human.

In one aspect, there is provided a tissue-simulating structure comprising:
a polymer; and
a lubricant.

In one example, the polymer is polyurethane rubber, silicone, silicone rubber, or combinations thereof.

In one example, the polyurethane rubber has a Shore hardness of between 5A and 90A.

In one example, wherein the polyurethane rubber has a Shore hardness of 5A, 10A, 20A, 30A, 40A, 50A, 60A, 70A, 80A or 90A.

In one example, the lubricant is mineral oil, glycerin, jojoba oil, olive oil, polyurethane softening agent or combinations thereof.

In one example, the lubricant is about 5% wt/wt to about 50% wt/wt, relative to the total amount of polymer.

In one example, the lubricant is about 5% wt/wt, about 10% wt/wt, about 15% wt/wt, about 20% wt/wt, about 25%, wt/wt, about 30% wt/wt, about 35% wt/wt, about 40% wt/wt, about 45% wt/wt or about 50% wt/wt.

In one aspect there is provided a tissue-simulating structure, comprising:
a polymer;
a lubricant; and
a porous material.

In one example, the polymer is polyurethane rubber, silicone, silicone rubber, or combinations thereof.

In one example, the polyurethane rubber has a Shore hardness between 5A and 90A.

In one example, the lubricant is a mineral oil, glycerin, jojoba oil, olive oil, polyurethane softening agent or combinations thereof.

In one example, the lubricant is mineral oil.

In one example, the lubricant is about 5% wt/wt to about 50% wt/wt.

In one example, the lubricant is about 5% wt/wt, about 10% wt/wt, about 20% wt/wt, about 30% wt/wt, about 40% wt/wt or about 50% wt/wt.

In one example, the porous material comprises one or more layers of open-cell polyurethane foam or another synthetic foam, or natural fabric, or felt, or combinations thereof.

In one example, the porous material comprises one or more layers of open-cell polyurethane foam.

In one example, the porous material comprises one or more layers of 1/16″ to ½″ open-cell polyurethane foam.

In one example, the porous material comprises a total of ⅛″ thickness of open-cell polyurethane foam.

In one example, the porous material has a ⅛″ thickness in areas where the fat and muscle layers are thinner, ¼″ in areas of medium thickness and ½″ where the fat and muscle layers are thicker.

In one example, the surface of the polymer includes skin-like texture, for example, Langer's lines (a surface pattern that follows the collagen orientation within the dermis).

In one example, further comprising a flexible mesh fabric.

In one example, the mesh comprises polyamide.

In one example, the mesh comprises nylons or a synthetic or natural elasticized fabric.

In one aspect, there is provided a tissue-simulating structure comprising:
a polymer; and
a softener.

In one example, the polymer is polyurethane rubber, silicone, silicone rubber, or combinations thereof.

In one example, the polyurethane rubber has a Shore hardness of between 5A and 30A.

In one example, the polyurethane rubber has a Shore hardness of 5A, 6A, 7A, 8A, 9A, 10A, 11A, 12A, 13A, 14A, 15A, 16A, 17A, 18A, 19A, 20A, 21A, 22A, 23A, 24A, 25A, 26A, 27A, 28A, 29A, or 30A.

In one example, the softener is a polyurethane softening agent, such as So-Flex.

In one example, the softener is about 5% wt/wt to about 30% wt/wt, relative to the total amount of polymer.

In one example, the softener is about 5% wt/wt, about 6% wt/wt, about 7% wt/wt, about 8% wt/wt, about 9% wt/wt, about 10% wt/wt, about 11% wt/wt, about 12% wt/wt, about 13% wt/wt, about 14% wt/wt, about 15% wt/wt, about 16% wt/wt, about 17% wt/wt, about 18% wt/wt, about 19% wt/wt, about 20% wt/wt, about 21% wt/wt, about 22% wt/wt, about 23% wt/wt, about 24% wt/wt, about 25% wt/wt, about 26% wt/wt, about 27% wt/wt, about 28% wt/wt, about 29% wt/wt, or about 30% wt/wt, relative to the total amount of polymer.

In one example, further comprising a lubricant, wherein the lubricant is mineral oil, glycerin, jojoba oil, olive oil, polyurethane softening agent or combinations thereof.

In one example, the lubricant is about 5% wt/wt to about 20% wt/wt, relative to the total amount of polymer.

In one example, the lubricant is about 5% wt/wt, about 6% wt/wt, about 7% wt/wt, about 8% wt/wt, about 9% wt/wt, about 10% wt/wt, about 11% wt/wt, about 12% wt/wt, about 13% wt/wt, about 14% wt/wt, about 15% wt/wt, about 16% wt/wt, about 17% wt/wt, about 18% wt/wt, about 19% wt/wt, or about 20% wt/wt, relative to the total amount of polymer.

In one example, further comprising an extension-limiting component.

In one example, the extension-limiting component is braided thread, braided multifilament thread, monofilament thread, suture material, wire, fishing line, yarn, rope, fabric, a minimally-extensible plastic or combinations thereof.

In one example, the extension-limiting component is braided multifilament thread.

In one example, the extension-limiting component is braided multifilament thread with a breaking strength of at least 25 lbf.

In one example, the extension-limiting component is attached to a point on each connecting bone, thereby limiting the movement of the bones relative to each other.

In one example, the extension-limiting component is disposed on an exterior surface of the tissue-simulating structure, passing outside the corresponding structure being limited.

In one example, the extension-limiting component passes inside the corresponding structure being limited.

In one aspect, there is provided a tissue-simulating structure, comprising:
a polymer; and
elongated fibers.

In one example, the polymer is polyurethane rubber, silicone, silicone rubber, or combinations thereof.

In one example, the polymer is polyurethane rubber having a Shore hardness between 5A and 90A.

In one example, the polymer is a silicone rubber.

In one example, the elongated fibers comprise animal fiber, preferably silk, horse hair, wool, human hair, non-human animal hair, synthetic fiber, preferably acrylic, polyester, polyvinyl chloride (PVC); and/or organic fibers, preferably cotton, hemp, or bamboo.

In one example, the elongated fibers are silk fibers.

In one example, the elongated fibers are oriented according to the structure, in a substantially parallel direction or substantially perpendicular direction or substantially cross-hatched pattern or substantially fanned layout or substantially at the periphery of the tissue-simulating structure or in random directions or combinations thereof.

In one example, the structure includes a deliberate tear or disruption to represent an anatomical defect.

In one aspect, there is provided a tissue-simulating structure comprising:
a polymer; and
an extension-limiting component.

In one example, the extension-limiting component is braided thread, braided multifilament thread, monofilament thread, suture material, wire, fishing line, yarn, rope, fabric, a minimally-extensible plastic or combinations thereof.

In one example, the extension-limiting component is inside or outside the polymer.

In one example, the polymer is polyurethane, or silicone, or silicone rubber, or combinations thereof.

In one aspect, there is provided a tissue-simulating structure comprising:
a polymer; and
a thin rubber-like membrane.

In one example, the thin rubber-like membrane is natural or synthetic rubber latex or nitrile rubber or neoprene or isoprene to create tactile resistance to surgical instruments.

In one example, the polymer is polyurethane, or silicone, or silicone rubber, or combinations thereof.

In one example, the thin rubber-like membrane has a thickness of between 0.05 mm and 0.5 mm.

In one example, further comprising one or more anchors disposed on an outer surface of said tissue-simulating structure.

In one example, the anchor comprises: a polyurethane rubber with a Shore hardness of 40A-90A, preferably 60A, preferably the anchor is a barb.

In one aspect, there is provided a tissue-simulating structure, comprising:
a biopolymer; and
a plasticizer.

In one example, the biopolymer is a gelatin, polysaccharide, preferably, seaweeds, such as algae, alginate, kappa carrageenan, or agarose, vegetable starch, guar gum, chitosan, pectin, or ground fruit pits), or polylactic acid (PLA), and further comprising water.

In one example, the plasticizer is glycerin or mineral oil.

In one aspect, there is provided a tissue-simulating structure, comprising:
a biopolymer; and
a hardener.

In one example, the biopolymer is a gelatin, polysaccharide, preferably, seaweeds, such as algae, alginate, kappa carrageenan, or agarose, vegetable starch, guar gum, chitosan, pectin, ground fruit pits, or polylactic acid (PLA), and further comprising water.

In one example, the hardener is a polymer.

In one example, the polymer is a polyurethane casting resin.

In one aspect, there is provided a muscle composite, comprising:
a simulated muscle belly, a first end and a second end;
the first end comprising a first tendon, the second end comprising a second tendon;
the simulated muscle belly comprising silicone or silicone rubber;
the first tendon comprising polyurethane rubber, having a Shore hardness between 5A and 90A;
the second tendon comprising an elasticized material; and
a musculotendinous junction connecting the muscle belly and the first tendon.

In one example, further comprising elongated fibers.

In one example, the elongated fibers comprise animal fiber, preferably silk, horse hair, wool, human hair, non-human animal hair, synthetic fiber, preferably acrylic, polyester, polyvinyl chloride (PVC); and/or organic fibers, preferably cotton, hemp, or bamboo.

In one example, the elongated fibers are silk fibers.

In one aspect, there is provided a method of producing a musculotendinous junction, comprising:
providing a muscle composite comprising a simulated muscle belly and a first end;
the first end comprising a first tendon;
the muscle belly comprising silicone or silicone rubber;
the first tendon comprising polyurethane rubber, having a Shore hardness between 5A and 90A; and
elongated fibers attached to said first end of said muscle belly and to the first tendon.

In some examples, the elasticized materials may be a spring, an elastic band, an elastic fabric, or the like.

In one example, the elongated fibers comprise animal fiber, preferably silk, horse hair, wool, human hair, non-human animal hair, synthetic fiber, preferably acrylic, polyester, polyvinyl chloride (PVC); and/or organic fibers, preferably cotton, hemp, or bamboo.

In one example, the elongated fibers are silk fibers.

In one example, the elongated fibers are disposed within the muscle.

In one example, the simulated muscle belly and first tendon are coated with a silicone-adhesive composite, or a silicone, or kappa carrageenan.

In one example, the silicon-adhesive composite is Sil-poxy.

In some example, the silicone-adhesive composite provides a fascia-like surface. It will be appreciated that a fascia is a band or sheet of connective tissue, primarily collagen, beneath the skin that attaches to, stabilizes, encloses, and separates muscles and other internal organs. In the present application, the fascia refers to a thin layer on top of the synthetic muscle (e.g., the tissue-simulating structure) that can be separated from the rest of the synthetic muscle, enhancing the tactile sensation and visual experience of surgery.

In some examples, a polyurethane rubber is chosen over another material such as silicone, especially for skin, ligaments, tendons, meniscus and labrum because of its minimal shrinkage, strength, durability, and better adhesion capabilities. It is much less likely to tear than silicone, and holds sutures better.

In some examples, silicone is chosen over another material such as polyurethane rubber, especially for muscles, because of the softer, gel-like tactile feel and viscoelastic properties.

Mineral oil is preferred as a lubricant because: it softens the rubber and adds lubrication throughout the skin or other tissue-simulating structure. This creates a self-lubricating feature, which is helpful to prevent binding of rotary instruments.

In some examples, foam is preferred in addition because: of its ability to absorb the polyurethane and break up the rubber, making it easier to penetrate, while remaining stretchable, and there are no fibers to tangle with the instruments during reaming. It also adds a multiple layered effect that adds a more skin-like feel when being cut.

In some examples, felt is preferred because it is stronger than foam while remaining porous. Felt may be acrylic, polyester, rayon or a rayon/viscose blend, wool, blended wool, cotton, hemp, bamboo or other fibers.

In some examples, polyamide mesh (nylons) are preferred because: they may add structure to the skin shape, contain the foam layer, and add strength to be more resilient to tearing. Since the purpose of the mesh is primarily to contain the foam rather than as a structural or tactile element itself, a number of alternatives are possible including other synthetic elasticized fabrics or natural elasticized meshes made from cotton, hemp, bamboo or other fibers.

In some examples, the tissue-simulating structure does not tear or bind when being cut with a reamer.

In some examples, a tissue-simulating structure with skin-like properties comprises: polyurethane rubber with a Shore hardness of 30A, and mineral oil.

In some examples, a tissue-simulating structure with multi-layer skin-like properties comprises: a skin-like layer of polyurethane rubber with a Shore hardness of 30A, and mineral oil, ⅛″ foam, and a fat-like layer of polyurethane rubber with a Shore hardness of 10A having and mineral oil soaked into the foam.

In some examples, a tissue-simulating structure with ligament-like properties comprises polyurethane rubber with a Shore hardness of 30A and substantially-parallel elongated fibers. In some examples, fibers (such as silk fibers, horse hair, elastic fibers, cotton batting, raw wool or acrylic yarn) may be added to the ligaments. In other examples, foam or felt may be added. In some examples, the density, layout and length of the fibers can be varied to change the properties of the ligaments.

In some examples, a tissue-simulating structure with tendon-graft-like properties comprises polyurethane rubber with a Shore hardness of 60A and substantially-parallel elongated fibers.

In some examples, a tissue-simulating structure with tendon-like properties comprises polyurethane rubber with a Shore hardness of 30A and substantially parallel or cross-hatched elongated fibers.

In some examples, a tissue-simulating structure with joint-capsule-like properties comprises polyurethane rubber with a Shore hardness of 60A with substantially cross-hatched elongated fibers.

In some examples, a tissue-simulating structure with meniscus-like properties comprises polyurethane rubber with a Shore hardness of 30A and substantially circumferential elongated fibers.

In some examples, a tissue-simulating structure with muscle-like properties comprises both a tendon-like structure attached to the bone and a muscle-belly-like structure attached to the tendon, whereby the components are joined by adhering fibers to the tendon-like structure and embedding them into the muscle belly, covering the surface of the tendon-like structure and other tissue-simulating structures in a fascia-like structure, embedding elasticized connectors on the opposite end of the muscle and adhering the tendon-like structure and connectors to the bone. In some examples, the tendon-like structure comprises polyurethane rubber with a Shore hardness of 30A. In some examples, the muscle-belly-like structure comprises alternating layers of fibers and silicone rubber gel, both for appearance and structure. In some examples, the fibers are silk fibers, horse hair, elastic fibers, cotton batting, raw wool or acrylic yarn. In some examples, the fascia-like structure is a silicone-adhesive composite.

It is understood that Vytaflex is only one type of polyurethane rubber and polyurethane rubbers are only one type of elastomeric rubber.

It is understood that the oils listed are only provided as examples of lubricants.

It is understood that the urethane foams, fabric and felt are only provided as examples of porous materials.

In some examples, further comprising a thin rubber-like sheet such as latex (natural or synthetic), whereby synthetic latex materials include: polyvinyl chloride (vinyl or PVC), nitrile rubber (acrylonitrile-butadiene copolymers), and polychloroprene known by its trade name, Neoprene™. Synthetic latex is non-allergenic and more resistant to oils compared to natural rubber latex.

In some aspects, there is provided a tissue-simulating structure of any one of as described herein further comprising elongated fibers.

In some examples, a meniscus-like structure (for example with a premade tear) is made to be replaceable by incorporating anchors that removably embed into holes in a bone or bone-like structure. This permits a user to remove the meniscus-like structure containing the anchors from the bone (for example in a knee joint), and to replace with a new meniscus-like structure containing the anchors. For example, in the case in which the initial meniscus-like structure is used to perform a meniscal repair, and a subsequent new meniscus-like structure with the same or different premade tear replaces the initial meniscus-like structure so the repair procedure may be repeated.

Accordingly, it will be appreciated that the anchors are sized for removable insertion in a receiving portion, such as in a structure including, but not limited to, an artificial bone, or bone-like.

In some examples, the anchors may be barbed anchors that are in the shape of drywall anchors and are made of a more rigid material (for example, Vytaflex 60) compared to the meniscus-like material (for example, Vytaflex 30).

It should be understood that many different mechanical attachment mechanisms, such as keyways, hooks, screws, buttons or Velcro can be used to as anchors.

It will be appreciated that anchors may be used with any of the tissue-simulating structures as described herein.

In some aspects there is described a tissue-simulating structure, comprising:
an outer skin-like sleeve; and
a muscle-simulating insert that provides structure and radial tension to the flexible skin-like sleeve to prevent it from collapsing, further aiding in reaming through the skin, and also, in the case of the knee joint, pushing the tibia against the edge of the skin-like sleeve such that the tibia can be palpated.

Methods of the invention are conveniently practiced by providing the compounds and/or compositions used in such methods in the form of a kit. Such a kit preferably contains the composition. Such a kit preferably contains instructions for the use thereof.

The basic method of creating the tissue-simulating structures is to mix together parts A and B of the polymer, then add the lubricant in the given wt/wt %, mix together, degas in a vacuum chamber and then pour into a mold of the given shape, after which it is left to set.

When a porous material is included, it is laid in or onto the mold; the liquid material is poured around it, which then absorbs into the porous material and sets.

When a mesh is included, it is placed over the porous material, to contain the porous material in the mold.

When a thin rubber-like material (such as latex or an alternative) is included, it is laid in the mold and the liquid poured on top, embedding the rubber-like material in the polymer.

The mold may be a flat or tubular mold, or may be a roughly cylindrical mold, with the outer cylinder having any texture desired on the inside surface and the inner cylinder being shaped to provide the desired variable thickness of the resulting sleeve-like casting, and with an alignment jig to align the inner and outer cores consistently. Alternatively, the polymer can be applied on the outside of a mold having texture, a different polymer (representing fat) applied on top of the skin layer, and the entire skin then turned inside out to have the texture on the outside. As an additional option, a smaller replaceable portion can be produced and combined with a larger fixed skin-like structure.

In order to integrate polymers with different Shore hardnesses, such as with the anchors on the replaceable meniscus, or stiffer ligaments (MCL, LCL) on the joint capsule, the material that protrudes further (e.g. the anchors or ligaments) is poured into the mold first, allowed to set until tacky but not fully cured, and then the second material is poured on top.

To gain a better understanding of the invention described herein, the following examples are set forth. It should be understood that these examples are for illustrative purposes only. Therefore, they should not limit the scope of this invention in any way.

### Uses

It will be appreciated that, in some non-limiting examples, tissue-simulating structures and synthetic models described herein may be utilized by one or more of the following end-users in human or veterinary medicine applications: medical students; medical residents (e.g., practicing knee, shoulder or hip arthroscopic surgery, joint replacement, spine procedures or trauma procedures); surgeons (e.g., learning to use new implants, instruments or technologies, surgical navigation or robot-assisted techniques, certification, re-certification, practicing a case preoperatively on a patient-specific generated model, training residents, or demonstrating the anatomy to a patient); engineers or technicians (e.g., conducting product verification testing or biomechanical testing); sales personnel (e.g., product demonstrations); educators (e.g. anatomical teaching to students and patients); and children (e.g., educational toys).

In some examples, the synthetic models described herein may be used for product demonstrations that use models to illustrate aspects of the product.

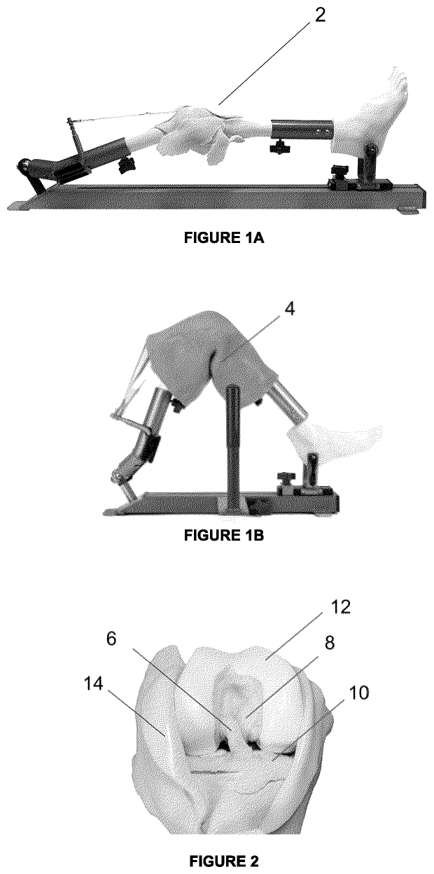

FIG. 1A depicts a knee joint (2) with soft tissues.

FIG. 1B depicts a knee joint with a skin sleeve (4).

FIG. 2 depicts a front view of a knee joint with soft tissues, including an anterior cruciate ligament (ACL) (6), posterior cruciate ligament (PCL) (8), meniscus (10), cartilage (12) and capsule (14).

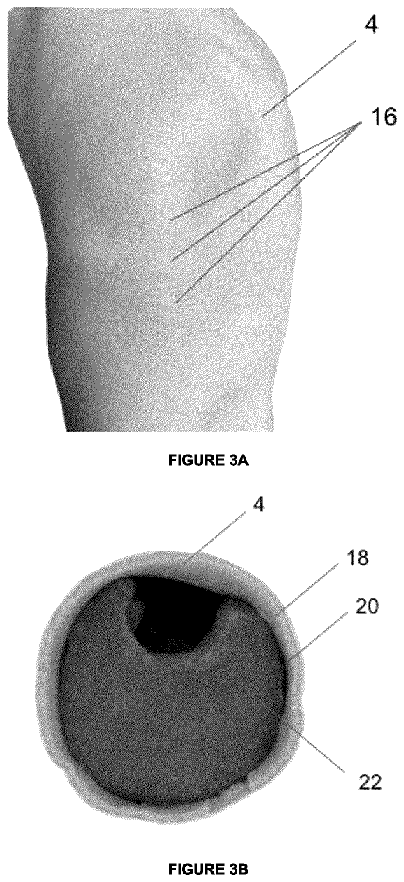

FIG. 3A depicts a skin sleeve (4) with Langer's lines (16).

FIG. 3B depicts a skin sleeve (4) with an outer skin layer (18), inner fat layer (20) and muscle-simulating insert (22).

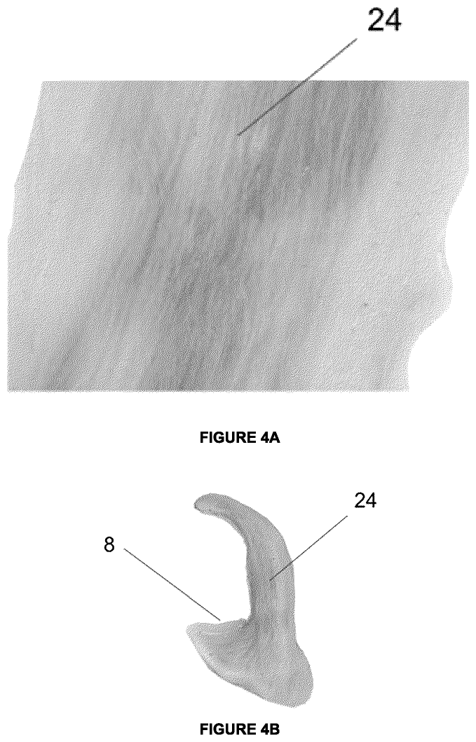

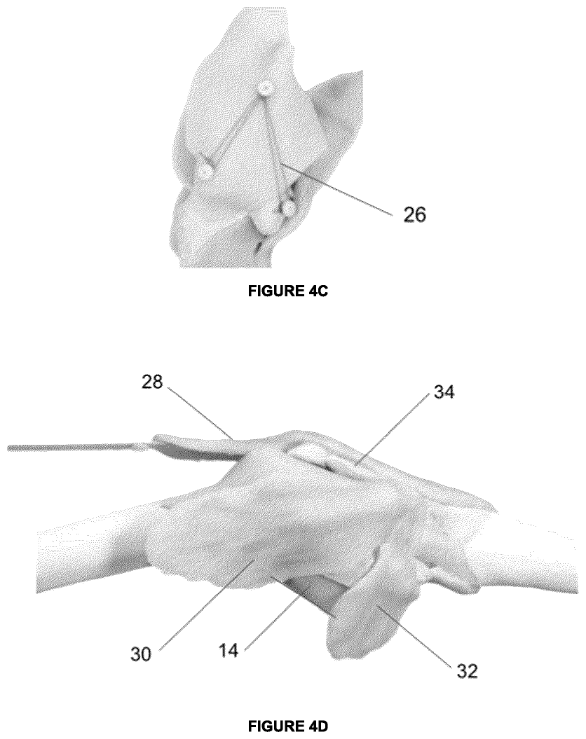

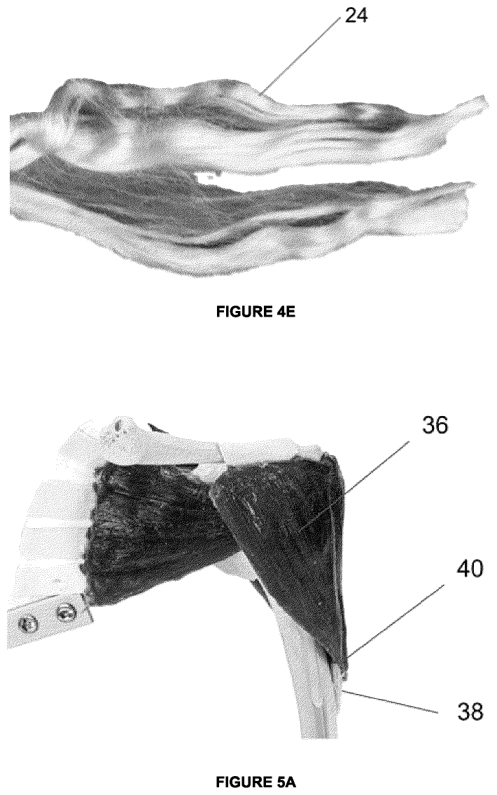

FIG. 4A depicts a ligament made from elongated fibers (24) embedded in a polymer.

FIG. 4B depicts a posterior cruciate ligament (8) made from elongated fibers (24) embedded in a polymer.

FIG. 4C depicts a side view of a knee, showing an extension-limiting component (26), which limits the amount that the knee can rotate sideways (into the page), mimicking anatomic behavior.

FIG. 4D depicts a side view of a knee, showing the combined patellar ligament and quadriceps tendon (28), iliotibial (IT) band (30), biceps femoris (32), fat pad (34) and capsule (14).

FIG. 4E depicts elongated fibers (silk fibers) (24) being cut to a given length and divided into a given number of segments, to be spread into a mold for embedding into a polymer.

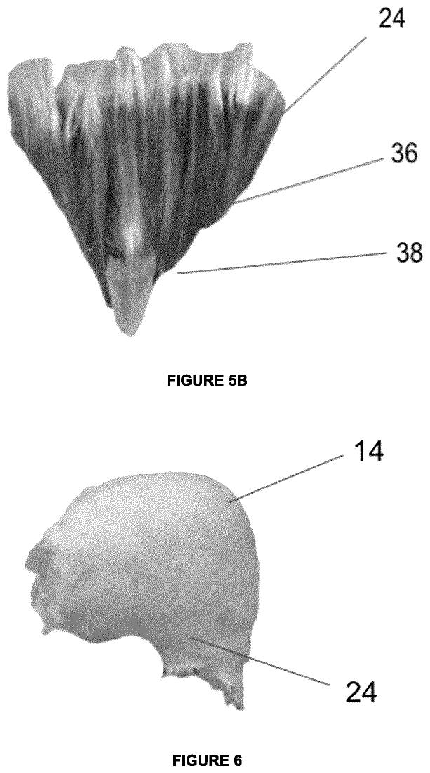

FIG. 5A depicts a muscle (36), tendon (38) and musculotendinous junction (40) demonstrated on a shoulder model.

FIG. 5B depicts elongated fibers (24) adhered to a tendon (38) and embedded into a muscle (36) to form a musculotendinous junction, to be covered by another layer of silicone rubber to complete the muscle belly.

FIG. 6 depicts a thin capsule (14) with embedded fibers (24) for the shoulder joint.

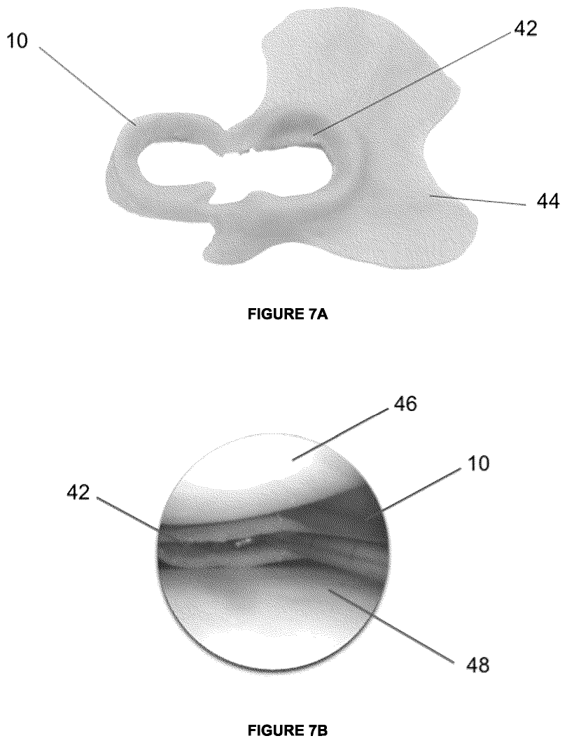

FIG. 7A depicts a meniscus (10) with horizontal cleavage tear (42) and capsular extension (44).

FIG. 7B depicts an arthroscopic camera view of horizontal cleavage tear (42) in meniscus (10) between the femur (46) and tibia (48) in a synthetic knee joint.

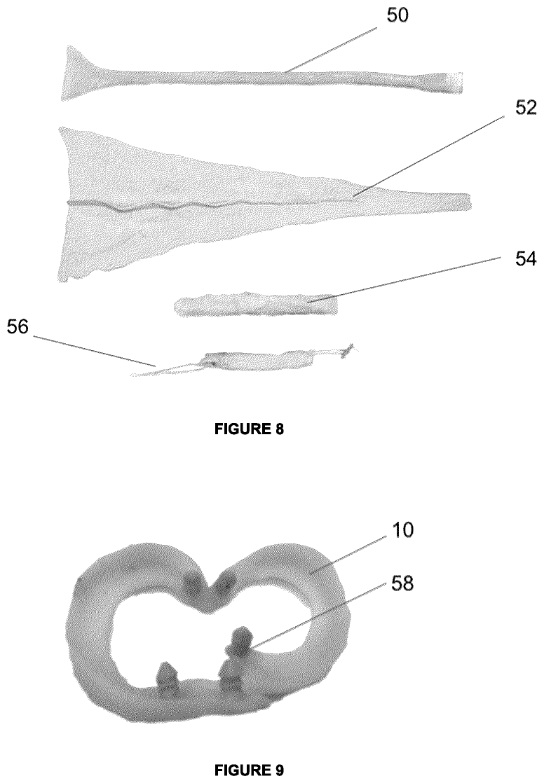

FIG. 8 depicts a synthetic hamstring tendon autograft (50), a synthetic Achilles tendon allograft (52), and a synthetic quadriceps tendon (54) with attached sutures (56).

FIG. 9 depicts a meniscus (10) with anchors (58) to allow replacement, for example for different meniscal tears.

The selected examples each represent a single combination of materials chosen within a possible and allowable range. These are examples only, and not intended to be limiting.

Table 1 provides an example of skin-like tissue.

TABLE 1
Skin-like tissue

| Skin outer-layer materials | Amounts |
|---|---|
| Polyurethane: Vytaflex 30 (Part A) | 150 g |
| Polyurethane: Vytaflex 30 (Part B) | 150 g |
| Mineral oil | 30 g (10% wt/wt vs resin) |
| (Preferred with) Urethane cure | 7 g (1.4% wt/wt vs resin) |
| accelerator (Kick-It) | |
| (Preferred with) Open-cell foam | ⅛″ throughout cutting region |

Table 2 provides an example of fat-like tissue under skin-like tissue.

TABLE 2
Fat-like tissue under skin-like tissue

| Skin fat-layer materials | Amounts |
|---|---|
| Polyurethane: Vytaflex 10 (Part A) | 225 g |
| Polyurethane: Vytaflex 10 (Part B) | 225 g |
| Mineral oil | 45 g (10% wt/wt vs total resin) |
| (Preferred with) Urethane cure | 9 g (2% wt/wt vs total resin) |
| accelerator (Kick-It) | |

Table 3 provides an example of thicker skin-like tissue.

TABLE 3
Thicker skin-like tissue

| Thicker skin materials | Amounts |
|---|---|
| Polyurethane: Vytaflex 10 (Part A) | 350 g |
| Polyurethane: Vytaflex 10 (Part B) | 350 g |
| Mineral oil | 70 g (10% wt/wt vs total resin) |
| (Preferred with) Open-cell foam | ⅛″ throughout cutting region; |
| | +¼″ in thicker areas + |
| | ½″ in thickest areas |
| (Preferred with) Polyamide (nylons) | Pulled over foam and inner core |
| | for molding |

Table 4 provides an example of muscle-like tissue.

TABLE 4
Muscle-like tissue

| Muscle materials | Amounts |
|---|---|
| Silicone rubber (Ecoflex) | 100-400 g (depending on size) |
| Mineral oil | 20% wt/wt vs silicone |
| (Preferred with) Open-cell foam | ⅛″ throughout muscle |
| (Preferred with) Silk fibers | Spread thinly longitudinally |
| | across muscle |

Table 5 provides an example of cartilage-like tissue.

TABLE 5
Cartilage-like tissue

| Skin outer layer materials | Amounts |
|---|---|
| Polyurethane: Task 11 (Part A) | 15 g |
| Polyurethane: Task 11 (Part B) | 15 g |
| Mineral oil | 3 g (10% wt/wt vs total resin) |

Note:
This combines the medial and lateral cartilage surfaces.

Table 6 provides an example of fat-pad-like tissue (i.e. the anatomical structure under the kneecap).

TABLE 6
Fat-pad-like tissue

| Fat pad materials | Amount |
|---|---|
| Polyurethane: Vytaflex 20 (Part A) | 30 g |
| Polyurethane: Vytaflex 20 (Part B) | 30 g |
| Urethane softener (So-Flex) | 15 g (25% wt/wt vs total resin) |

Table 7 provides an example of a posterior septum of the knee.

TABLE 7
Posterior septum of the knee

| Posterior septum materials | Amounts |
|---|---|
| Polyurethane: Vytaflex 20 (Part A) | 50 g |
| Polyurethane: Vytaflex 20 (Part B) | 50 g |
| Mineral oil | 5 g (5% wt/wt vs total resin) |
| Urethane softener (So-Flex) | 25 g (25% wt/wt vs total resin) |

Table 8 provides an example of anterior and posterior cruciate ligaments.

TABLE 8
Anterior and posterior cruciate ligaments

| ACL and PCL materials | Amounts |
|---|---|
| Polyurethane: Vytaflex 30 (Part A) | 30 g |
| Polyurethane: Vytaflex 30 (Part B) | 30 g |
| Silk fibers (start with 2 cm wide bunch) | ACL: 3 cm long × 0.5 mm |
| For ACL: 3 cm; divide into 42 segments | diameter |
| For PCL: 5 cm; divide into 5 segments | PCL: 5 cm long × 4 mm |
| | diameter |

Note:
The silk fibers used are Tussah Silk Fiber used in felting.

Table 9 provides an example of a combined patellar ligament and quadriceps tendon.

TABLE 9
Combined patellar ligament + quadriceps tendon

| Patellar ligament/quads materials | Amounts |
|---|---|
| Polyurethane: Vytaflex 30 (Part A) | 120 g |
| Polyurethane: Vytaflex 30 (Part B) | 120 g |
| Silk fibers (start with 2 cm wide bunch) | 10 cm × 0.4 mm diameter, |
| For body: 10 cm; divide into 5 segments | laid out longitudinally and |
| | spread across ligament |

Table 10 provides an example of a combined medial collateral ligament+popliteus+posterior oblique ligament.

TABLE 10
Combined medial collateral ligament + popliteus + posterior oblique
ligament

| Posteromedial ligament materials | Amounts |
|---|---|
| Polyurethane: Vytaflex 30 (Part A) | 160 g |
| Polyurethane: Vytaflex 30 (Part B) | 160 g |
| Silk fibers | Popliteus: 15 cm × 0.7 mm |
| (start with 2 cm wide bunch) | diameter, laid out longitudinally, |
| For popliteus: 15 cm; divide into 3 | spread across ligament |
| For MCL: 10 cm; divide into 6 | MCL: 10 cm × 0.3 mm diameter, |
| For POL: 10 cm; divide into 6 | spread across ligament |
| | POL: 10 cm × 0.3 mm diameter, |
| | spread across ligament |

Table 11 provides an example of a combined iliotibial band+biceps femoris.

TABLE 11
Combined iliotibial band + biceps femoris

| Lateral ligament materials | Amounts |
|---|---|
| Polyurethane: Vytaflex 30 (Part A) | 160 g |
| Polyurethane: Vytaflex 30 (Part B) | 160 g |
| Silk fibers | IT band: 13 cm × 0.4 mm diameter, |
| (start with 2 cm wide bunch) | laid out longitudinally, |
| For IT band: 13 cm; divide into 5 | spread across ligament |
| For biceps: 5 cm; divide into 5 | Biceps: 5 cm × 0.4 mm diameter, |
| | spread across ligament |

Table 12 provides an example of a rotator cuff tendon of the shoulder.

TABLE 12
Rotator cuff tendon of the shoulder

| Tendon materials | Amount |
|---|---|
| Polyurethane: Vytaflex 30 (Part A) | 7.5 g |
| Polyurethane: Vytaflex 30 (Part B) | 7.5 g |
| Silk fibers (start with 2 cm wide bunch) | Adhere 3 cm at end of fibers |
| For tendon: 10 cm; not divided | to tendon for attachment |
| | to muscle; cross-hatched |
| | to ensure good suture strength |

Note:
Different tendons will require different amounts of polymer and lengths of fibers.

Table 13 provides an example of a combined medial/lateral menisci+capsular flap.

TABLE 13
Combined medial/lateral menisci + capsular flap

| Capsulomeniscal materials | Amounts |
|---|---|
| Polyurethane: Vytaflex 30 (Part A) | 100 g |
| Polyurethane: Vytaflex 30 (Part B) | 100 g |
| Silk fibers (start with 2 cm wide bunch) | Body: 23 cm × 0.7 mm diameter, |
| For body: 23 cm; divide into 3 segments | placed around edge |
| For large flap: 7 cm | Large flap: 7 cm long, fanned out |
| For small flap: 6 cm | Small flap, 6 cm long, fanned out |

Note #1:
The labrum is similar to the menisci, with fibers placed around the edge.
Note #2:
The menisci/labrum may be manufactured alone or with the capsular flap.
Note #3:
The menisci, labrum or tendons may have deliberate tears or defects built in or created to train the surgical techniques of repairing them.

Table 14 provides an example of periosteum-like tissue.

TABLE 14
Periosteum-like tissue

| Periosteum materials | Amounts |
|---|---|
| Polyurethane: Vytaflex 50 (Part A) | 100 g |
| Polyurethane: Vytaflex 50 (Part B) | 100 g |
| Silk fibers | Cross-hatch a thin layer |
| (start with 2 cm wide bunch) | densely in parallel and |
| Length as needed to cover surface | perpendicular directions |

Table 15 provides an example of tendon grafts.

TABLE 15
Tendon grafts

| Tendon graft materials | Amounts |
|---|---|
| Polyurethane: Vytaflex 60 (Part A) | 15 g to 50 g depending on graft |
| Polyurethane: Vytaflex 60 (Part B) | 15 g to 50 g depending on graft |
| Silk fibers (start with 2 cm wide bunch) | Lay densely longitudinally |
| Length as needed to extend full length | |

Note:
The Achilles tendon uses 30A, all others use 60A.

Table 16 provides an example of shoulder-capsule-like tissue.

TABLE 16
Shoulder-capsule-like tissue

| Shoulder capsule materials | Amounts |
|---|---|
| Polyurethane: Vytaflex 50 (Part A) | 15 g |
| Polyurethane: Vytaflex 50 (Part B) | 15 g |
| Silk fibers (start with 2 cm wide bunch) | Cross-hatch in a dense, |
| 10 cm long | thin layer across |
| | the capsule |

Table 17 provides an example with extension-limited ligaments.

TABLE 17
Extension-limited ligaments

| Replaceable meniscus materials | Amounts |
|---|---|
| Polyurethane: Vytaflex 30 (Part A) | See Tables 8-11 |
| Polyurethane: Vytaflex 30 (Part B) | See Tables 8-11 |
| Silk fibers | See Tables 8-11 |
| Extension-limiting component | Braided multifilament thread |

Note #1:
The braided thread may be on the outside of the ligament, embedded in the ligament, or passing through a tube in the ligament.
Note #2:
The extension-limiting component may take many forms, including any long material that can be tied, or a fibrous material or fabric.

Table 18 provides an example of a knee capsule with a tactile “pop” sensation.

TABLE 18
Knee capsule with tactile “pop”

| Capsule-materials¤ | Amounts¤ |
|---|---|
| Polyurethane:•Vytaflex•30•(Part•A)¤ | 100•g¤ |
| Polyurethane:•Vytaflex(Part•B)¤ | 100•g¤ |
| Latex•rubber•sheet¤ | Cut•out•and•embedded•in•polymer¤ |

Table 19 provides an example of cartilage-like and other tactile tissues.

TABLE 19
Cartilage-like and other tactile tissues

| Materials | Amounts |
|---|---|
| Polyurethane: Task 11 (Part A) | 10 g |
| Polyurethane: Task 11 (Part B) | 10 g |
| Plasticizer: Glycerin | 2 g (10% wt/wt vs total resin) |

Note:
This material is considerably softer than the cartilage-like material in Table 5.

Table 20 provides one example of superficial cartilage and other softer tactile tissues.

TABLE 20
Superficial cartilage and other softer tactile tissues - option #1

| Materials | Amounts |
|---|---|
| Biopolymer: Gelatin | 15 g |
| Plasticizer: Glycerin | 200% wt/wt vs gelatin |
| Water | 10 g |

Note:
Superficial cartilage layer is softer than the mid-deep layers.

Table 21 provides another example of superficial cartilage and other softer tactile tissues.

TABLE 21
Superficial cartilage and other softer tactile tissues - option #2

| Materials | Amounts |
|---|---|
| Biopolymer: Alginate or kappa | 5 g |
| carrageenan | |
| Plasticizer: Glycerin | 100% wt/wt vs alginate |
| Water | 10 g |

Note:
The alginate or kappa carrageenan is water soluble.

Table 22 provides one example of mid-deep cartilage and other harder tactile tissues.

TABLE 22
Mid-deep cartilage and other harder tactile tissues - option #1

| Materials | Amounts |
|---|---|
| Biopolymer: Alginate or kappa | 15 g |
| carrageenan | |
| Hardener: Smooth-Cast 300 casting resin | 85% wt/wt vs alginate |
| Water | 10 g |

Note:
Mid-deep cartilage is harder than the superficial layer.

Table 23 provides a second example of mid-deep cartilage and other harder tactile tissues.

TABLE 23
Mid-deep cartilage and other harder tactile tissues - option #2

| Materials | Amounts |
|---|---|
| Biopolymer: Gelatin | 10 g |
| Biopolymer: Alginate or kappa | 50% wt/wt vs gelatin |
| carrageenan | |
| Water | 10 g |

Table 24 provides an example of a method of a musculotendinous junction.

TABLE 24
Method: Musculotendinous junction

| Musculotendinous materials | Amounts |
|---|---|
| Tendons, adhered to bone | Table 12 or similar, or |
| | elasticized material |
| Muscle, attached to tendon | Table 4 |
| Silk fibers, adhered to tendon, in muscle | Thin, dense layer |
| (Preferred with) Sil-poxy | Thin layer over muscle & |
| | tendon |

Table 25 provides an example of a method of replaceable meniscus.

TABLE 25
Method: Replaceable meniscus

| Replaceable meniscus materials | Amounts |
|---|---|
| 1st Polymer: Vytaflex 60 (Part A) | 10 g |
| 1st Polymer: Vytaflex 60 (Part B) | 10 g |
| 2nd Polymer: Vytaflex 30 (Part A) | 60 g |
| 2nd Polymer: Vytaflex 30 (Part B) | 60 g |

Note:
The 1st polymer is poured into the mold to form anchors, left until tacky without fully curing, then the 2nd polymer is poured into the mold, bonding the two polymers together.

Table 26 provides an example of a method of producing a skin-like tissue with a muscle insert.

TABLE 26
Method: Skin with muscle insert

| Skin with insert materials | Amounts |
|---|---|
| Skin sleeve | Tables 1-3 |
| Muscle insert: disc-like or leg-like | Polyurethane FlexFoam-iT |

Note:
The muscle insert helps to maintain the structure and shape of the skin sleeve.

Skin is the softest of the tissue-simulating structures, is easier to cut and preferably includes a skin-like texture, particularly with Langer's lines; it should not tear when cut, should be suturable (without tearing), and should be reamable (without binding or getting caught in fibers). The next softest are the meniscus, joint capsule, ACL and PCL. The menisci have a layered effect, whereby the upper layer is more fibrous than the lower layer. Ligaments primarily carry tension forces, with elongated fibers along the length of the ligaments. The stiffest structures are the MCL, LCL and tendons. These may be further supported with largely inextensible connectors, such as braided thread, that becomes taut with increased displacement of the ligaments. The tendons should be suturable to act as tendon grafts and may be mainly flat (hamstrings) or mainly cylindrical (quadriceps).

Table 27 provides a summary of the materials that may be used, and corresponding simulated-structures and tissue(s).

Table 28 provides a summary of methods that may be used.

TABLE 27
Summary of materials, examples and tissue-like structures

| Component 1 | Component 2 | Component 3 | Component 4 | Example Tissue(s) |
|---|---|---|---|---|
| | | | | Skin, fat, fat pad, septum, muscle, |
| Polymer: | Lubricant: | — | — | cartilage, bursa |
| Polyurethane | Mineral oil | | | Skin & fat layers (Tables 1-3) |
| 10A-30A | (10%) | | | |
| Silicone rubber | Mineral oil | | | Muscles (Table 4) |
| Ecoflex | (20%) | | | |
| Polyurethane | Mineral oil | | | Cartilage (Table 5) |
| Task 11 | (10%) | | | |
| | | Porous | | |
| Polymer: | Lubricant: | Material: | — | Skin, Muscle |
| Polyurethane | Mineral oil | Open-cell foam | | Skin (Tables 1 & 3) |
| 10A-30A | (10%) | (⅛″-½″) | | |
| Silicone rubber | Mineral oil | Open-cell foam | | Muscles (Table 4) |
| Ecoflex | (20%) | (⅛″-½″) | | |
| | | Porous | Flexible Mesh | |
| Polymer: | Lubricant: | Material: | Fabric: | Skin |
| Polyurethane | Mineral oil | Open-cell foam | Polyamide | Skin (Table 3) |
| 10A-30A | (10%) | (⅛″-½″) | (Nylons) | |
| | | (Optional: | | |
| Polymer: | Softener: | Lubricant): | — | Fat pad & septum |
| Polyurethane | So-Flex | | | Fat pad (Table 6) |
| 20A | (10%) | | | |
| Polyurethane | So-Flex | Mineral oil | | Septum (Table 7) |
| 20A | (10%) | (5%) | | |
| | | (Optional: | | |
| | | Extension- | | Ligaments, tendons, menisci, |
| | | limiting | | labrum, periosteum, muscle, |
| Polymer: | Elongated Fibers: | component) | — | grafts, capsule |
| Polyurethane | Silk fibers | | | Ligaments (Tables 8-11) |
| 30A | throughout | | | Tendons (Table 12) |
| | | | | Menisci + capsule, labrum (Table 13) |
| Polyurethane | Silk fibers | | | Periosteum (Table 14) |
| 50A | throughout | | | |
| Polyurethane | Silk fibers | | | Tendon grafts (Table 15) |
| 30A | throughout | | | |
| Polyurethane | Silk fibers | | | Capsule (Table 16) |
| 60A | throughout | | | |
| Polyurethane | Silk fibers | Braided | | Extension-limited ligaments (Table |
| 30A | throughout | multifilament | | 17) |
| | | thread | | |
| | Extension-Limiting | | | |
| Polymer: | Component: | — | — | Ligaments |
| Polyurethane | Multifilament | | | Extension-limited ligaments (Table |
| 30A | braided thread | | | 17) |
| | Rubber-Like | | | |
| Polymer: | Membrane: | — | — | Capsule with tactile ‘pop’ |
| Polyurethane | Thin rubber sheet | | | Capsule (Table 18) |
| 30A | | | | |
| | | | | Cartilage, bursa, fat, fat pad, |
| Polymer: | Plasticizer: | — | — | muscle, intervertebral disc |
| Polyurethane | Glycerin | | | Cartilage (Table 19) |
| Task 11 | (10%) | | | |
| | | | | Cartilage, bursa, fat, fat pad, |
| Biopolymer: | Plasticizer: | — | — | muscle, intervertebral disc |
| Gelatin | Glycerin | | | Superficial cartilage (Table 20) |
| | (200% vs gelatin) | | | |
| Alginate | Glycerin | | | Superficial cartilage (Table 21) |
| | (100% vs gelatin) | | | |
| | | | | Cartilage, bursa, fat, fat pad, |
| Biopolymer: | Hardener: | — | — | muscle, intervertebral disc |
| Alginate | Polyurethane | | | Cartilage - mid-deep (Table 22) |
| | (85% vs alginate) | | | |
| First | Second | | | Cartilage, bursa, fat, fat pad, |
| biopolymer: | biopolymer: | — | — | muscle, intervertebral disc |
| Gelatin | Alginate | | | Cartilage (Table 23) |
| | (50% vs gelatin) | | | |

TABLE 28
Summary of method, example and tissues

| | | | Component 4 | |
|---|---|---|---|---|
| | | Component 3 | Silicone- | |
| Component 1 | Component 2 | Elongated | adhesive | |
| Tendons: | Muscles: | fibers: | composite | Example Tissue(s) |
| Polyurethane | Silicone rubber | Silk fibers | Sil-poxy | Musculotendinous junction |
| 30A | Ecoflex | | | (Table 25) |

The embodiments described herein are intended to be examples only. Alterations, modifications and variations can be effected to the particular embodiments by those of skill in the art. The scope of the claims should not be limited by the particular embodiments set forth herein, but should be construed in a manner consistent with the specification as a whole.

All publications, patents and patent applications mentioned in this Specification are indicative of the level of skill of those skilled in the art to which this invention pertains and are herein incorporated by reference to the same extent as if each individual publication patent, or patent application was specifically and individually indicated to be incorporated by reference.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1.-75. (canceled)

76. A tissue simulating structure for use in surgical training, the structure comprising at least two of:
a) a polymer,
b) a lubricant,
c) a porous material,
d) elongated fibers, and
e) an extension-limiting component.

77. The tissue simulating structure of claim 76, wherein the polymer is selected from polyurethane rubber, silicone, silicone rubber, a biopolymer, or combinations thereof.

78. The tissue simulating structure of claim 76, wherein the polymer is polyurethane rubber having a Shore hardness between 5A and 90A.

79. The tissue simulating structure of claim 76, wherein the lubricant is mineral oil, glycerin, jojoba oil, olive oil, polyurethane softening agent, or combinations thereof.

80. The tissue simulating structure of claim 76, wherein the lubricant is about 5% wt/wt to about 50% wt/wt, relative to the total amount of polymer.

81. The tissue simulating structure of claim 76, wherein the lubricant is mineral oil.

82. The tissue simulating structure of claim 76, wherein the lubricant is glycerin.

83. The tissue simulating structure of claim 76, wherein the porous material is one or more layers of open-cell polyurethane foam, another synthetic foam, natural fabric, natural felt, or combinations thereof.

84. The tissue simulating structure of claim 76, wherein the porous material comprises one or more layers of 1/16″ to ½″ open-cell polyurethane foam.

85. The tissue simulating structure of claim 76, wherein the elongated fibers comprise animal fiber, silk, human hair, non-human animal hair, synthetic fiber, acrylic, polyester, polyvinyl chloride (PVC), organic fibers, cotton, hemp, bamboo, or combinations thereof.

86. The tissue simulating structure of claim 76, wherein the elongated fibers are silk fibers.

87. The tissue simulating structure of claim 76, wherein the elongated fibers are oriented according to the structure or tensile or normal forces, in a substantially parallel direction or substantially perpendicular direction or substantially cross-hatched pattern or substantially fanned layout or substantially at the periphery of the tissue-simulating structure or in random directions or combinations thereof.

88. The tissue simulating structure of claim 76, wherein the extension-limiting component is braided thread, braided multifilament thread, monofilament thread, suture material, wire, fishing line, yarn, rope, fabric, a minimally-extensible plastic or combinations thereof.

89. The tissue simulating structure of claim 76, wherein the extension-limiting component is positioned inside or outside the polymer, mimicking the anatomic behaviour of ligaments positioned between bones and restricting movement of the bones relative to each other.

90. The tissue simulating structure of claim 76, wherein the polymer comprises a skin-like texture to mimic Langer's lines.

91. The tissue simulating structure of claim 76, wherein the structure further comprises one or more anchors disposed on an outer surface of the tissue-simulating structure for connecting the structure to at least one bone.

92. The tissue simulating structure of claim 76, wherein the biopolymer is gelatin, alginate, or kappa carrageenan.

93. The tissue simulating structure of claim 92, wherein, when the biopolymer is alginate or kappa carrageenan, the structure further comprises a hardener.

94. The tissue simulating structure of claim 76, wherein the structure is configured to form
at least one tendon-like structure, and
a muscle-like structure,
wherein the tendon-like structure and the muscle-like structure are connected by embedded elongated fibers to form a musculotendinous junction.

95. The tissue simulating structure of claim 94, wherein a first at least one tendon-like structure is positioned at a first end of the muscle-like structure for connecting the muscle-like structure to at least one bone.
